(19) United States
(12) Patent Application Publication
(10) Pub. No.: US 2005/0188785 A1
(43) Pub. Date: Sep. 1, 2005

(54) Synchronized mechanical power combiner

(76) Inventor: James Gerald Nugent, Alexandria, VA (US)

Correspondence Address: James G. Nugent, 8419 Blakiston Lane, Alexandria, VA, 22308, US

(21) Appl. No.: 10/787,151

(22) Filed: Feb. 27, 2004

(51) Int. Cl. F16H 37/06

(52) U.S. Cl. 74/665 A

(57) ABSTRACT

A mechanical power combiner that brings power in from multiple inputs and combines them into an output by using controls that depend on the motion of the inputs. The action of the clutching mechanism is coordinated so the clutch is synchronized during clutching and declutching and is positively locked.

### CROSS-REFERENCE TO RELATED APPLICATIONS

This invention is related to the synchronized mechanical continuously variable transmission of my co-pending application to be filed 2004 Mar. 1.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to power transmission, specifically an improved method of combining mechanical power flow.

2. Discussion of Prior Art

Clutching mechanisms are commonly used to engage power transmissions. A simple friction clutch is often used to engage the load during driving and disengage the load during idling or gear ratio changes. Some types of transmissions, notably continuously variable transmissions (CVTs), split power into multiple paths and then recombine the power prior to output.

Ratcheting CVTs such as the one shown in U.S. Pat. No. 5,334,115 use eccentric motion and multiple power arms that are combined into the output. The separate power paths in this case are each of the power arms. Each of these separate paths has a portion its motion that it is at the appropriate ratio to be locked to the output. For the portion of the motion for which the ratio is not matched, that path must be disconnected while another paths carries the load. The device used to accomplish this function is the commutator of U.S. Pat. No. 5,334,115. It has only discrete positions due to teeth being used for mechanical communication and it is inherently unable to provide a continous range of operation.

Another CVT that uses separated power paths is shown in U.S. Pat. No. 4,765,195. Exponential gears that are varied in phase to each other provide portions of a revolution of a shaft with the desired output speed. Here one-way clutches are used to combine the power onto the output shaft and to disengage the shafts at the times that they are not turning at the right speed. A lever type CVT as shown in U.S. Pat. No. 5,440,945 also has one-way clutches. The one-way clutches that are used in CVTs described above and many other designs have serious drawbacks.

There are several serious drawbacks to using one-way clutches. The first is that the transmission can only transmit power in one direction. Mechanical communication is one way. A one-way clutch overruns and is not able to provide functions such as engine braking. Benefits such as recovering energy during braking, or regenerative braking, cannot be realized. The reverse gear requires additional hardware.

A second drawback is that the friction that makes most one-way clutches work also causes wear, and the clutches are heavily used and have a small contact area. The clutches lock while under load. They are not synchronized. This causes slippage and additional wear. Ratchets also lock while under load, adding shock loads to the transmission. They also only lock at discrete locations, thus keeping the transmission from being truly continuously variable.

A third less obvious, but important drawback is that one way clutches can only choose the power path that is turning the fastest. In order to make use of the full range of ratios, some transmission designs require that the slower path be used for a range of ratios. In the case of a noncircular geared continuously variable transmission, being able to use the slower moving of the multiple power paths of the transmission gives it a much greater ratio range than an equivalent transmission with one way clutches.

Other clutching techniques are used such as pneumatic, manual, computer controlled, etc. No prior art technique smoothly controls clutching internal to the cycle of motion.

### OBJECTS AND ADVANTAGES

Accordingly, several objects and advantages of the present invention are:
(a) to provide a power combining mechanism that provides two way mechanical communication
(b) to provide a power combining mechanism that allows both overrunning and under running of unused power paths
(c) to provide a power combining mechanism that smoothly combines the inputs, avoiding discrete steps required by geared mechanisms
(d) to provide a power combining mechanism that synchronizes the driving and driven members prior to clutch engagement and ensures synchronization until the clutch is completely disengaged, thus increasing durability and decreasing unnecessary friction and heat generation
(e) to provide a power combining mechanism that is self powered and does not require outside energy such as hydraulic or pneumatic pressure from a pump or electric energy
(f) to provide a power combining mechanism that does not require outside control such as computer control or active operator control
(g) to provide a power combining mechanism that has low frictional losses
(h) to provide a power combining mechanism that support high torque loads

Further objects and advantages will become apparent from a consideration of the ensuing description and drawings.

### DESCRIPTION OF DRAWINGS

FIG. 1 shows an overall view of the power combiner in the midrange position

FIG. 2 shows the top view of the power combiner

FIG. 3 shows the front view of the left clutch assembly clutched

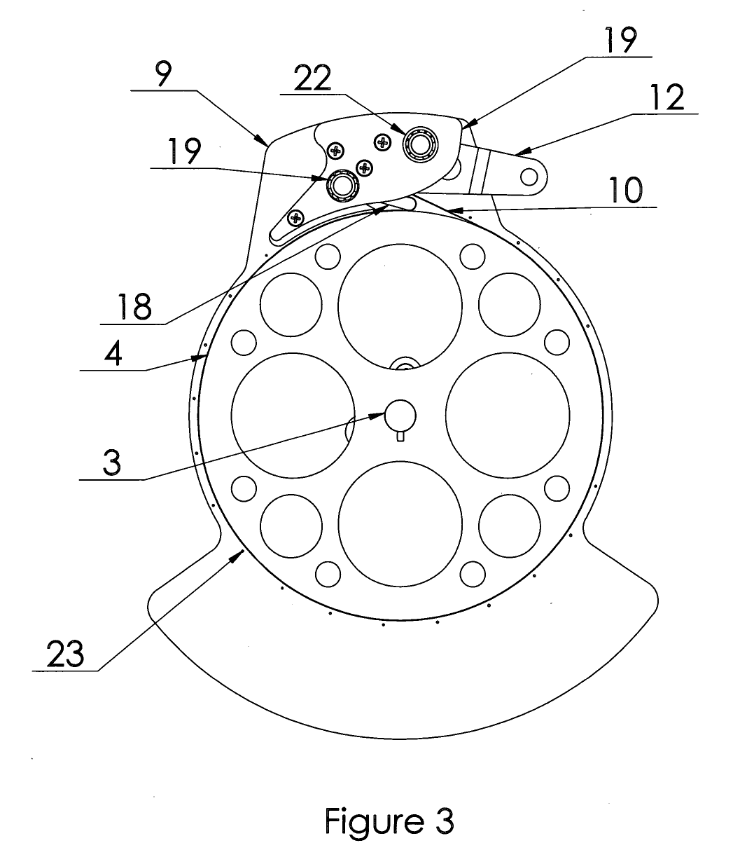

FIG. 4 shows the back view of the right clutch assembly unclutched

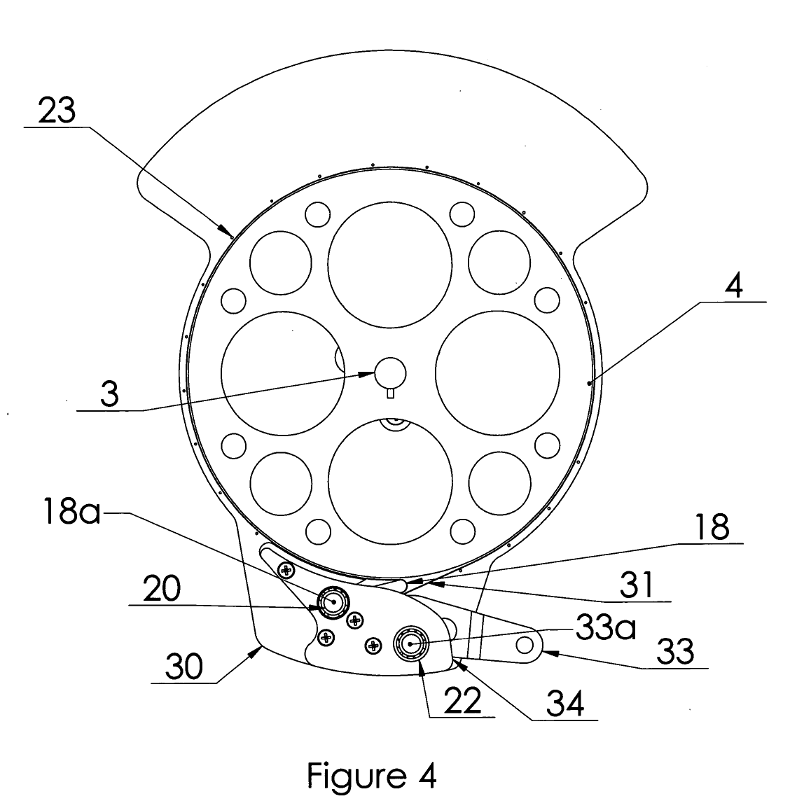

FIG. 5 shows the top view of the left and right clutch assemblies

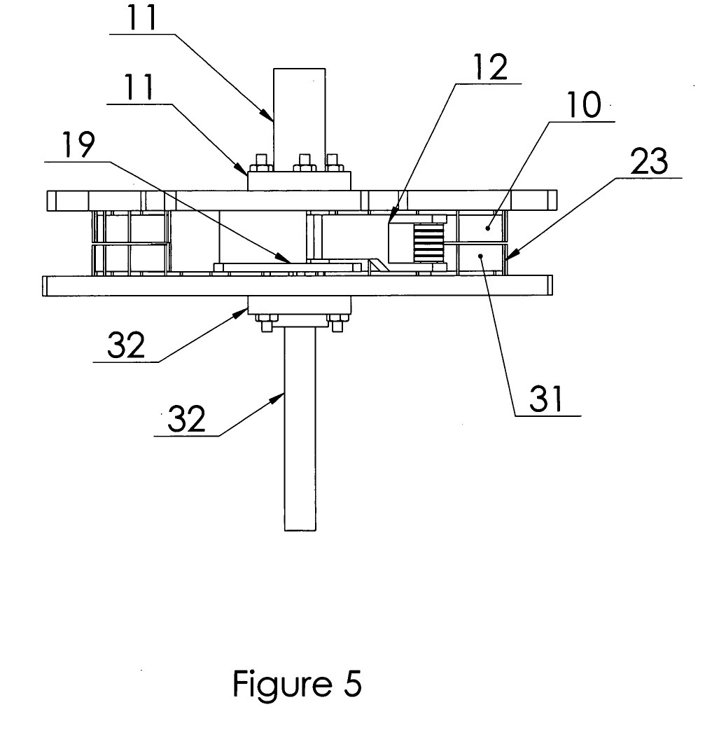

FIG. 6 shows details of cable guide, I beam, cam, and cables

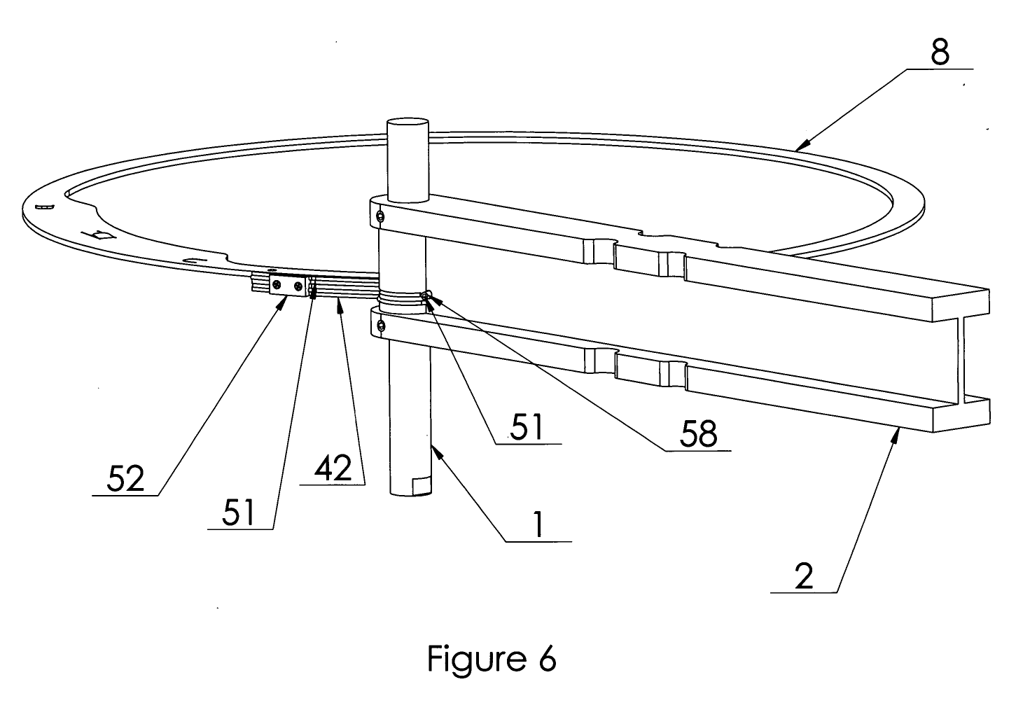

FIG. 7 shows the left arm and wheels

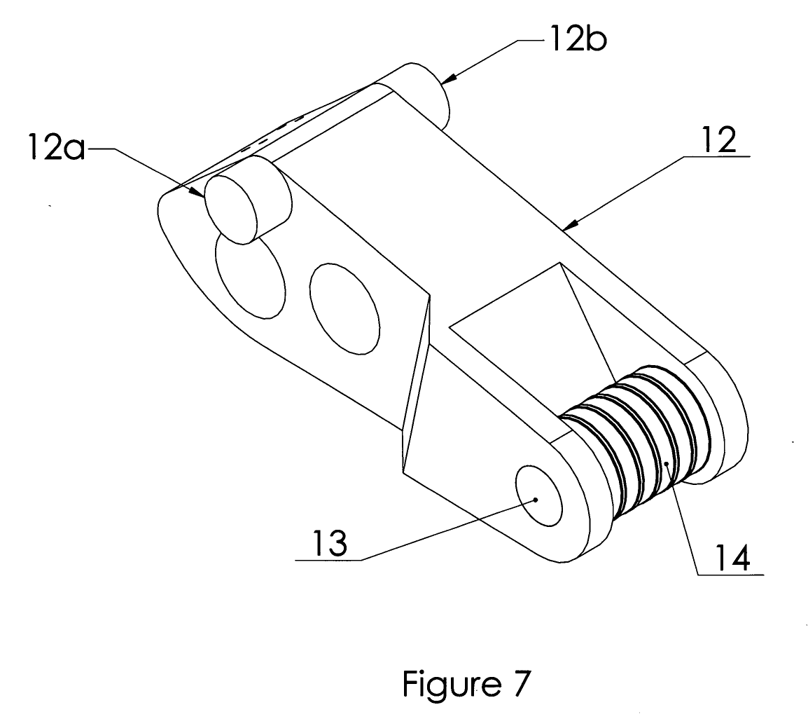

FIG. 8 shows the back view of the rings and the mechanism to position them midrange

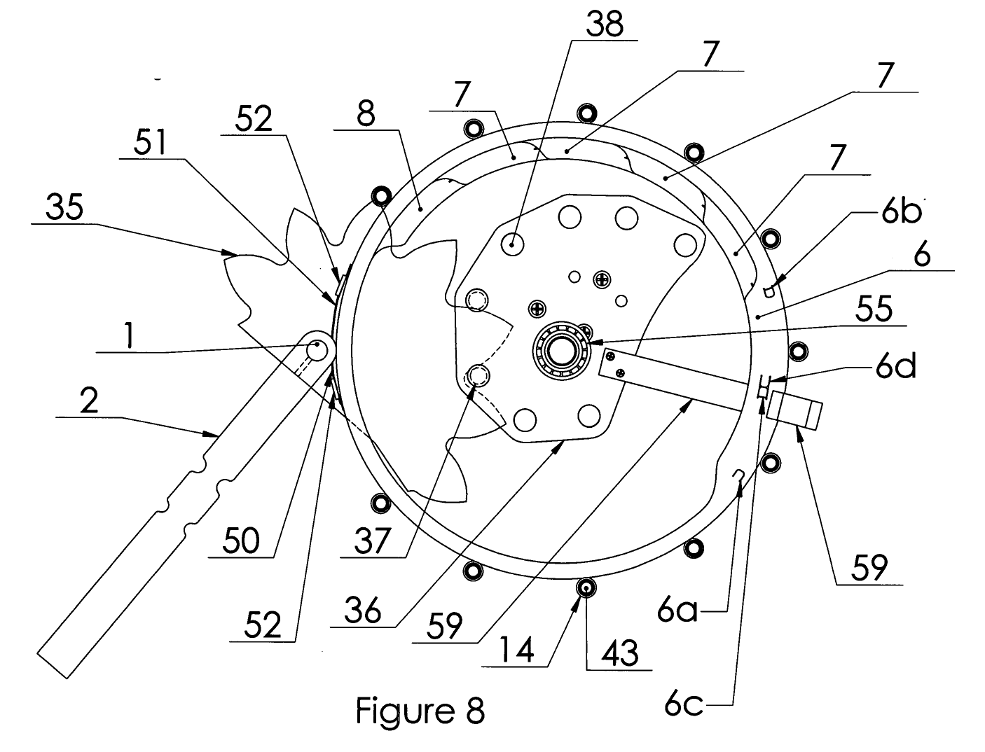

FIG. 9 shows the back view of the rings and the mechanism to position them lined up

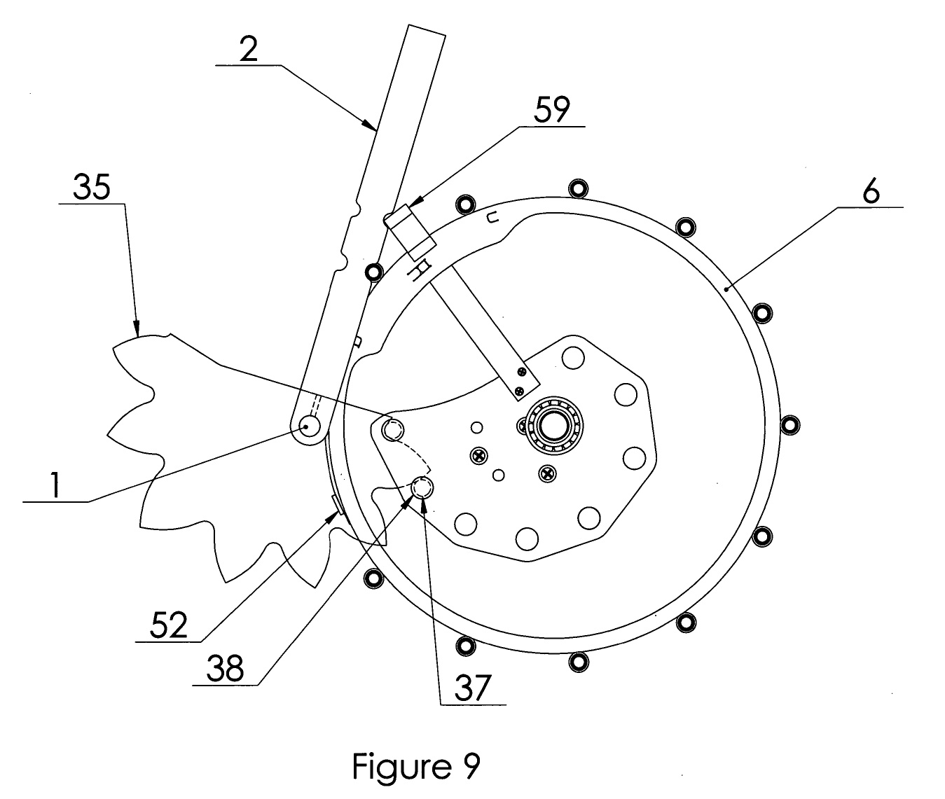

FIG. 10 shows the back view of the rings and the mechanism to position them fanned

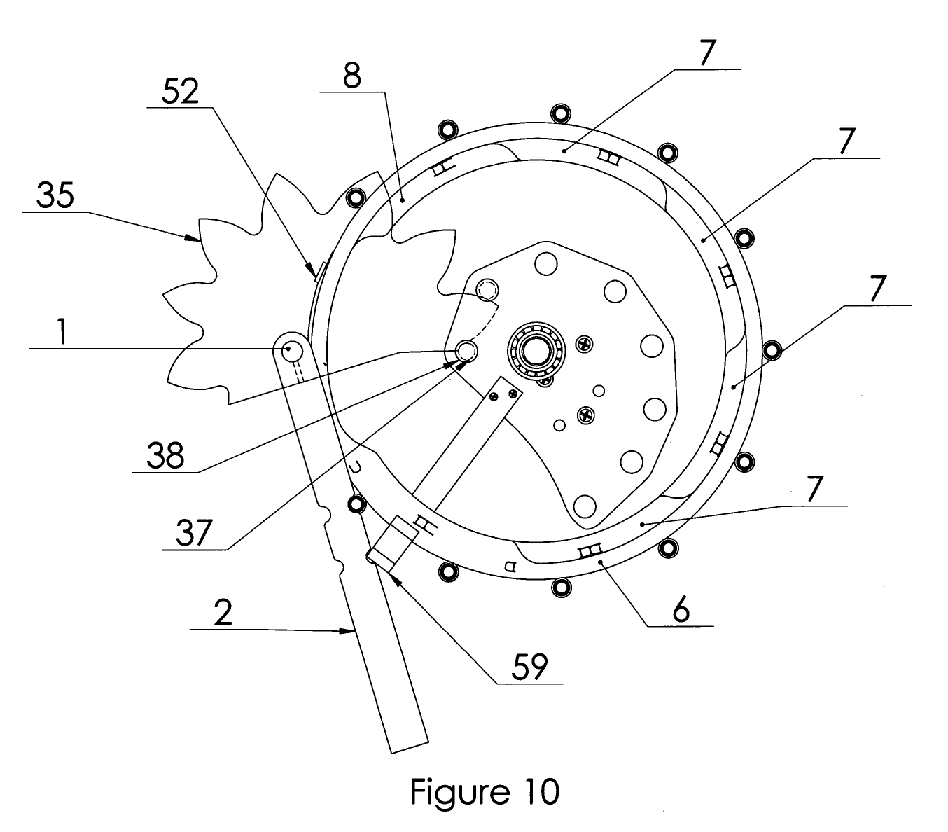

### DRAWINGS

### Reference Numerals

1 cam axle
2 I beam
3 drum axle
4 drum
5 key
6 low ring
7 central ring
8 high ring
9 left disk
10 left band
11 left hub
12 left arm
13 arm axle
14 wheel
15 wheel inner race
16 wheel ball
17 wheel outer race
18 pivot bar
19 left cover
20 bar inner race
21 bar ball
22 bar outer race
23 pin
24 screw
25 screw
26 nut
27 screw
28 nut
29 screw
30 right disk
31 right band
32 right hub
33 right arm
34 right cover
35 cam
36 control disk
37 roller
38 roller outer race
39 bearing roller
40 control hub
41 screw
42 cable guide
43 support axle
44 thin washer
45 thick washer
46 axle outer race
47 axle roller
48 left frame
49 right frame
50 high cable
51 low cable
52 clamp
53 hub inner race
54 hub ball
55 hub outer race
56 set screw
57 set screw
58 cable end
59 link
60 gear
61 screw
62 screw

### SUMMARY

### DESCRIPTION OF INVENTION

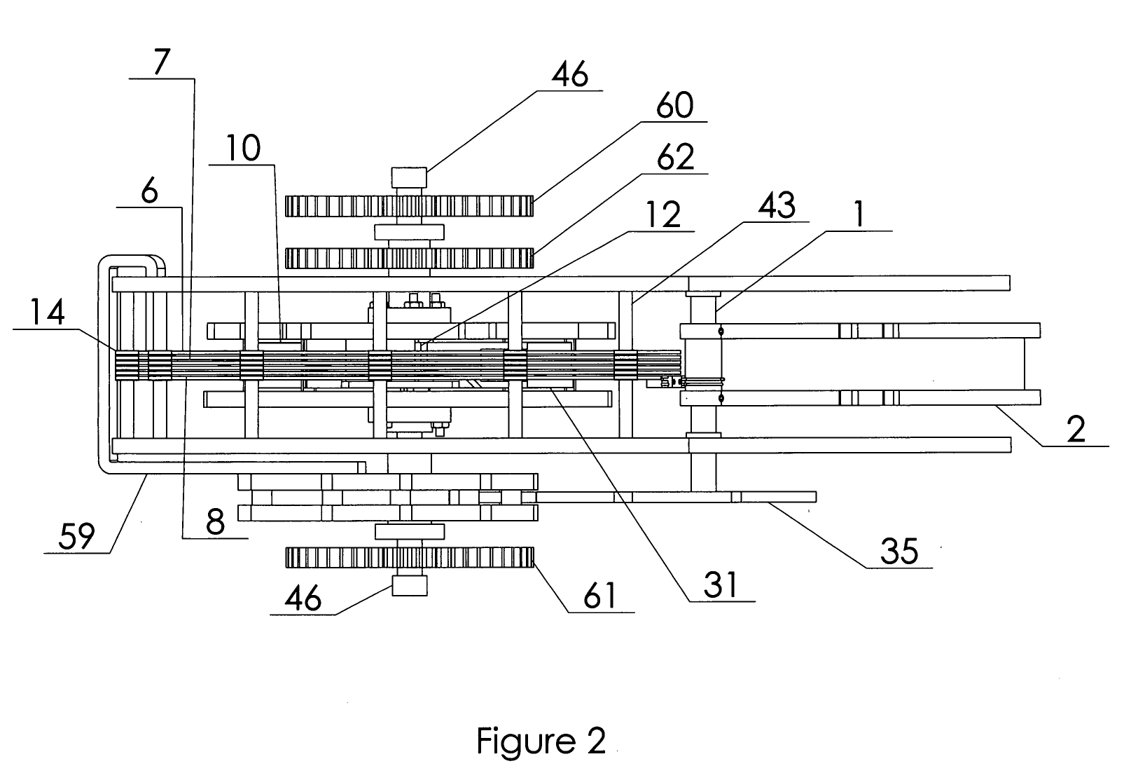

FIG. 2 shows a top view of the clutching mechanism. A supporting frame 48 with a front frame 48a and a back frame 48b support all the other parts. A set of supporting axles 43 is mounted between frames 48a and 48b. A set of constraining rollers 14 are mounted on each supporting axle 43, each positioned by a bearing. A set of clutch control cams consisting of a back clutch control cam 6, several central clutch control cams 7, and a front clutch control control cam 8. A cable 50 and a cable 51 are fastened to cable guide 42 by cable clamps 52. The opposite ends of cable 51 and cable 52 each is fastened to a cable end 58 and constrained within control arm 2. Front clutch control cam 8 is fastened to a control arm 2 by a cable 50 and a cable 51.

### OPERATION OF INVENTION

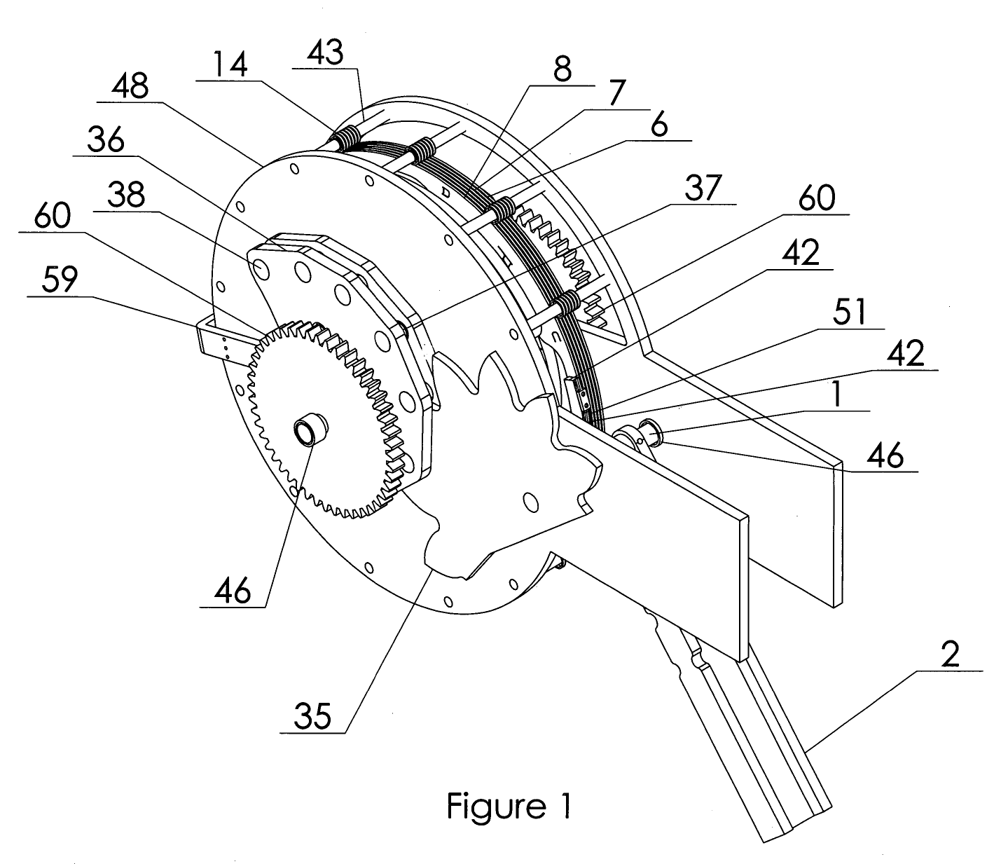

The preferred embodiment is shown in FIG. 1. The two inputs combine to make one output. For convenience, the two input gears are called input and the single drum shaft is called the output. Due to the clutches holding both forward and backward, the input and output could be reversed. There are two rotating shafts each turning a cam follower that controls the tension in a band clutch. A separate gear mechanism controls the position of the shafts. When the cam follower is on the part of the control cam assembly closer to the center, it is puts tension on the band and locks the band and the arm and the pivot in relation to the drum. The cam followers follow along an inward curve made up of six segments that can move. A fixed ratio gear determines the motion of the low-end clutch cam.

The present invention is controlled to match the clutched member. The clutch holds forward and backwards. By controlling the end points, the clutch is able to hold the slower moving of two pieces. By moving the control points, it is able to have only one side be locked. An additional benefit of this is that it minimizes the time when both clutches are clutched. Shifting is unconstrained when only one clutch is clutched.

### SUMMARY, RAMIFICATIONS, AND SCOPE

Accordingly, the reader will see that the synchronized mechanical power combiner of this invention can be used to smoothly combine multiple power inputs with low friction and high torque capacity while using no external power source. In addition, it supports torque both forward and backward with overrunning and underrunning of unused inputs while reducing wear and simplifying control.

Although the description above contains many specificities, these should not be construed as limiting the scope of the invention but as merely providing illustrations of some of the presently preferred embodiments of this invention. For example, the clutch is shown as a band but may have other forms such as a disk. Thus the scope of the invention should be determined by the appended claims and their legal equivalents, rather than by the examples given.

1. A power combining assembly, comprising:
an input power source having a plurality of torque transmitting means rotatable about a first rotation axis;
an output power source having a torque transmitting means rotatable about said rotation axis;
a control means;
a locking assembly rotatable about said rotation axis having a plurality of locking means interacting with said control means, and interacting with said input torque transmitting means,
the arrangement being such that, as said output torque transmitting means rotates through a cycle of 360 degrees, said locking means engages successive input torque transmitting means, and at least one of said locking means maintains mechanical communication with both input and output at all times during a complete cycle of output torque transmitting means.

2. A clutching assembly, comprising:
a clutched means rotatable about a first rotation axis;
a clutch control means having a plurality of cams and rotatable about said rotation axis, each cam being of a predetermined shape;
a clutching means rotatable about said rotation axis having a plurality of clutches interacting with said first clutch control means, and interacting with said clutched means,
the arrangement being such that, as said clutching means rotates through a cycle of 360 degrees, said clutching means engages successive cams along said clutch control means, and at least one of said clutches maintains mechanical communication with said clutched means at all times during a complete cycle of clutching means.

3. The assembly as claimed in claim 2, wherein said cams are at a larger radius on said rotation axis than said clutching means.

4. The assembly as claimed in claim 2, wherein said cams are at a smaller radius on said rotation axis than said clutching means.

5. The assembly as claimed in claim 2, wherein noncircular gears control the radial position of the cams.

6. The assembly as claimed in claim 2, wherein the clutched means is a drum and the clutching means is a band.
